(19) United States
(12) Patent Application Publication
(10) Pub. No.: US 2007/0191991 A1
(43) Pub. Date: Aug. 16, 2007

(54) Irrigation Controller Communication System

(75) Inventor: John W. Addink, Riverside, CA (US)

Correspondence Address: FISH & ASSOCIATES, PC;ROBERT D. FISH, 2603 Main Street, Suite 1050, Irvine, CA, 92614-6232, US

(73) Assignee: AQUA CONSERVE, INC., Riverside, CA (US)

(21) Appl. No.: 11/674,472

(22) Filed: Feb. 13, 2007

Related U.S. Application Data
(63) Continuation-in-part of application No. 11/347,521, filed on Feb. 2, 2006.
Application No. 11/347,521 is a continuation-in-part of application No. 11/217,252, filed on Aug. 31, 2005.
Application No. 11/217,252 is a continuation-in-part of application No. 10/297,146, filed on Aug. 11, 2003, now Pat. No. 6,963,808.

(51) Int. Cl. G05D 7/00

(52) U.S. Cl. 700/284

(57) ABSTRACT

An irrigation controller is programmed to automatically initiate communication with a data server to perform at least one of the following functions: (a) exchange irrigation data; (b) receive control data; and (c) receive synchronization data. The irrigation data can be station runtime history, evapotranspiration (ETo) data, rainfall, weather related information, irrigation faults and any other irrigation data. The control data can involve station runtime settings, cycle and soak settings, irrigation scheduling and any other irrigation control data. The synchronization data preferably includes a date and a time, originating from the data server, but can include other data that would be used to synchronize the communication between the irrigation controller and the data server. In a preferred embodiment of the present invention a microprocessor disposed in the irrigation controller is programmed to use the date and time to schedule a future contact with the data server.

### CROSS-REFERENCE TO RELATED APPLICATIONS

This application is a Continuation-In-Part of pending U.S. application Ser. No. 11/347,521, filed on Feb. 2, 2006, which is a continuation-in-part of U.S. patent application Ser. No. 11/217252, filed on Aug. 31, 2005, which is a continuation-in-part of U.S. patent application Ser. No. 10/297146, filed on Aug. 11, 2003, now issued as U.S. Pat. No. 6,963,808, which is a US national phase of PCT Application No. PCT/US00/15480, filed on Jun. 5, 2000, all of which are hereby incorporated by reference in their entirety.

### FIELD OF THE INVENTION

The field of the invention is water savings.

### BACKGROUND OF THE INVENTION

In arid areas of the world water is becoming one of the most precious natural resources. Meeting future water needs in these arid areas can require aggressive conservation measures. This in turn requires irrigation systems that apply water to the landscape based on the water requirements of the plants. Many irrigation controllers have been developed for automatically controlling application of water to landscapes. Known irrigation controllers range from simple devices that control watering times based upon fixed schedules, to sophisticated devices that vary the watering schedules according to local geography and climatic conditions.

With respect to the simpler types of irrigation controllers, a homeowner typically sets a watering schedule that involves specific run times and days for each of a plurality of stations, and the controller executes the same schedule regardless of the season or weather conditions. From time to time the homeowner may manually adjust the watering schedule, but such adjustments are usually only made a few times during the year, and are based upon the homeowner's perceptions rather than the actual landscape's watering needs. One change is often made in the late spring, when a portion of the yard becomes brown due to a lack of water. Another change is often made in the late fall, when the homeowner assumes that the vegetation does not require as much watering. These changes to the watering schedule are typically insufficient to achieve efficient watering.

More sophisticated irrigation controllers usually include some mechanism for automatically making adjustments to the irrigation run times to account for daily environmental variations. However, due to the complexity of these irrigation controllers, the homeowner, after the irrigation controller is initially installed, makes few if any changes to the irrigation controller settings and may not even check, if the irrigation controller is operating properly unless the landscape plant material begins browning and/or dying.

Additionally, since these irrigation controllers operate the irrigation system automatically, a typical homeowner makes no preparation for someone to check the system, such as when they are on vacation or otherwise absent from their residence for an extended period of time. Unfortunately, irrigation controllers are machines, and for any number of reasons they might fail to operate correctly, such as if the electricity to the residence is temporarily turned off.

Whether because of user disinterest, lack of knowledge in the operation of present automatic irrigation systems, or any other reason, there exists a need for cost-effective methods to assist irrigation users in attaining more efficient irrigation of their landscapes, and in the regular monitoring of their operation of the irrigation systems.

There are irrigation systems that are entirely or partly controlled by a distal computer, and/or receive information from a distal computer that is located at a remote site from the irrigation controller. Examples are disclosed in U.S. Pat. No. 5,208,855, issued May 1993, to Marian; U.S. Pat. No. 5,696,671, issued December 1997, and U.S. Pat. No. 5,870,302, issued February 1999, both to Oliver; U.S. Pat. No. 5,740,031, issued April 1998, to Gagnon; U.S. Pat. No. 5,748,466, issued May 1998, to McGivem, et al.; U.S. Pat. No. 6,298,285, issued October 2001, U.S. Pat. No. 6,892,114, issued May 2005, and U.S. Pat. No. 6,895,9867, issued May 2005, all to Addink, et al.; U.S. Pat. No. 6,453,216, issued September 2002, to McCabe, et al.; U.S. Pat. No. 6,600.971, issued July 2003 and U.S. Pat. No. 6,898,467, issued May 2005, both to Smith, et al. and U.S. Pat. No. 7,146,254, issued December 2006, to Howard. In all of these cases, the irrigation controllers are either controlled by the distal computers, and/or they receive information from the distal computers that is used in the calculation of run times. However, there is no information sent, from the irrigation controller back to the computer, to verify what the actual runtimes were for the various stations operated by the irrigation controller.

Additionally, there are irrigation systems having bidirectional communication of information between a distal computer and an irrigation controller. Some such systems are disclosed in U.S. Pat. No. 6,944,523, issued September 2005 and U.S. Pat. No. 6,950,728, issued September 2005, both to Addink, et al. where the information communication is initiated by the distal computer. U.S. Pat. No. 6,823,239, issued November 2004, to Sieminski also discloses bidirectional communication of information between an irrigation server and an irrigation controller in which the irrigation controller initiates calls to the irrigation server. However, the information transmitted involves only ‘station or mainline flow failures, as well as station wiring faults’ and does not include any transmissions of irrigation run-time history.

The above patents do not disclose irrigation controller initiated communication and/or do not involve the transmitting of data to perform at least one of the following functions: (a) exchange irrigation data; (b) receive control data; and (c) receive synchronization data.

### SUMMARY OF THE INVENTION

Methods and apparatus are provided herein in which an irrigation controller is programmed to automatically initiate communication with a data server to perform at least one of the following functions: (a) exchange irrigation data; (b) receive control data; and (c) receive synchronization data.

The irrigation data can be station runtime history, evapotranspiration (ETo) data, rainfall, weather related information, irrigation faults and any other irrigation data.

The control data can involve station runtime settings, cycle and soak settings, irrigation scheduling and any other irrigation control data.

The synchronization data preferably includes a date and a time, originating from the data server, but can include other data that would be used to synchronize the communication between the irrigation controller and the data server.

In a preferred embodiment of the present invention a microprocessor disposed in the irrigation controller is programmed to use the date and time to schedule a future contact with the data server.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWINGS

FIG. 1 is a schematic of a proposed irrigation controller that has a communication connection to a data server.

### DETAILED DESCRIPTION

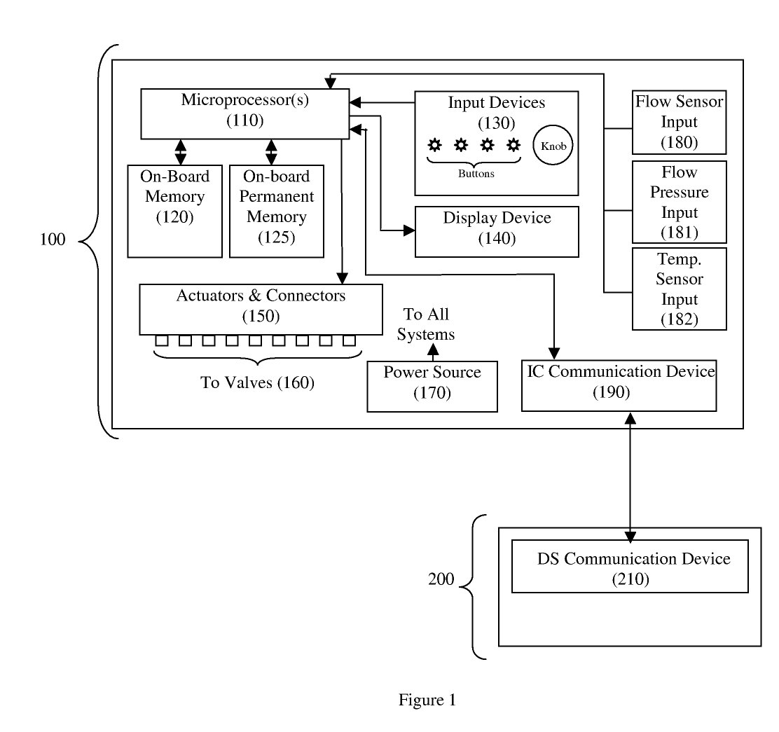

Referring to FIG. 1, preferred embodiments of the irrigation controller (100) include: one or more microprocessors (110) to perform calculations; on-board memory (120) (e.g., RAM) to store intermediate results; and on-board permanent memory (125) (e.g., EEPROM) to store persistent data, such as inputted values, previously measured values, and past irrigation activities (i.e., archived and historical values). In one embodiment of the current invention, computations and processes required by the irrigation controller (100) are carried out by at least partial partitioning of tasks among the one or more processors and memories.

The irrigation controller (100) can include manual input devices (130) (e.g., buttons and/or knobs) and a display device (140) (e.g., a text or graphic Liquid Crystal Display (LCD)) to enable interactions, provide feedback, and receive commands from an operator of the irrigation controller (100).

In one preferred aspect of the inventive subject matter, the irrigation controller (100) includes electrical actuators and connectors (150) corresponding to the plurality of irrigation stations. The actuators and connectors feed electrical signals to the valves (160) which control water flow to corresponding regions of the irrigation site. The electrical actuators are preferably based on electromechanical relays or solid-state electronic devices (e.g., TRIACs). Additionally, the irrigation controller (100) is contemplated to include a power source (170) (e.g., a Wall Transformer) to power the on-board electronics as well as to supply electricity to the irrigation valves.

Still further contemplated embodiments of the irrigation controller (100) include circuitry to accommodate a flow sensor input (180), an optional pressure sensor input (181), an optional temperature sensor input (182) and other sensors.

Additionally, in a preferred embodiment of the present invention the irrigation controller (100) has an on-board communication device. The irrigation controller communication device is hereinafter referred to as the IC communication device (190). It can be appreciated that instead of an on-board IC communication device (190) the IC communication device can be external to the irrigation controller (100) and the irrigation controller would include interface circuitry to use the external IC communication device (190). Preferably the IC communication device (190) is a telephone data modem (Modulator and Demodulator). Alternatively, the IC communication device (190) can be a pager, mobile telephone, local area network (LAN) adaptor, wireless area network (WAN) adaptor or any other appropriate communication device that allows the irrigation controller (100) to communicate with a data server (200).

The data server (200) can be a stand alone device, such as a computer. Alternatively, the data server (200) can be a microprocessor embedded into another device. Contemplated data servers (200) have an on-board communication device. The data server communication device is hereinafter referred to as the DS communication device (210). As with the irrigation controller (100), it can be appreciated that instead of an on-board communication device the DS communication device (210) can be external to the data server (200) and the data server would include interface circuitry to use the external DS communication device (210). Preferably the DS communication device (210) is a telephone data modem. Alternatively, the DS communication device (210) can be a pager, mobile telephone, local area network (LAN) adaptor, wireless area network (WAN) adaptor or any other type of appropriate communication device that allows the data server (200) to communicate with the irrigation controller (100).

It is contemplated that irrigation controller (100), using the IC communication device (190), can be programmed to periodically, and at a predetermined time, initiate a connection with the data server (200) via the DS communication device (210). With a telephone connection, by having the irrigation controller initiate the connection to the data server, there will be no daily telephone ring at the residence or business where the irrigation controller is located. Preferably, once the connection between the communication devices (190/210) is established, the data server (200) and the irrigation controller (100) exchange irrigation data. Examples of irrigation data that is exchanged includes station runtime history, evapotranspiration (ETo) data, rainfall, weather related information, flow sensor data, irrigation faults and any other irrigation data.

It is further contemplated that during the connection between the two communication devices (190/210) that the data server (200) will send information to the irrigation controller (100) that includes control data. The control data can involve station runtime settings, cycle and soak settings, irrigation scheduling and any other irrigation control data.

In addition to the control data, the data server (200) can advantageously send synchronization data to the irrigation controller (100). Synchronization data can include information which can be used by the irrigation controller (100) to synchronize its internal clock (time of day and date) with the clock of the data server (200). It is further contemplated that the synchronization data will include the time and date of the next communication, essentially instructing the irrigation controller (100) of the exact time/date when the next communication to the data server (200) is to take place. Additionally, when the communication device is a telephone data modem, synchronization data can include a telephone number to be used by the irrigation controller (100), when the irrigation controller initiates the next communication to the data server (200).

It is also advantageous to synchronize the internal clocks of the irrigation controller (100) and the data server (200) to permit for the greatest number of initiated communications between irrigation controllers (100) and the data server (200). In theory, the number of communications that can be accommodated during an m minute window of time is m/d where d is the duration of a single communication. For example, if the window of time is m=240 minutes and the duration of a communication is d=0.30 minutes, then a total of 240/0.30=480 communications can be accommodated over a single communication line. However, this theoretical number of communications can only be realized if the irrigation controllers (100) have synchronized internal clocks and are programmed to initiate a communication during non-overlapping times. Thus, it is essential for the data server (200) and irrigation controller (100) to use a time synchronization protocol in order to accurately maintain consistent internal clocks. Moreover, it is necessary for the data server (200) to assign an exact time that each irrigation controller (100) can initiate a communication to avoid overlapping communications. It is assumed that the data server (200) has means to maintain an exact internal clock. This is typically achieved using one of the common Internet time synchronization methods, such as the Network Time Protocol (NTP). Hence, in addition to maximizing the number of communications, time synchronization will eliminate the need for users to set their irrigation controller's (100) time and date. Furthermore it is contemplated that the irrigation controller (100) will automatically adjust for daylight saving.

It is further contemplated that the data server (200) can also send an alternate communication number to an irrigation controller (100), in essence redirecting future communications from that irrigation controller (100) to an alternate data server (200). One reason for this mechanism is to have a method to perform load balancing. In particular, when the number of irrigation controller (100) communications surpass the capacity of a data server (200), some of the irrigation controllers (100) can be directed to initiate communications to an alternate data server (200). Another reason for this mechanism is to help bootstrap a newly installed irrigation controller (100). The irrigation controller (100) can be programmed, at the factory, with a default communication number (for example, with a telephone data modem communication device it can be a Toll Free number). After the initial setup, the irrigation controller's (100) first communication to the data server (200) will be processed by a central data server (200). The central data server (200) will than assign the communication number of a local data server (200) to which subsequent communications will be initiated by the irrigation controller (100).

In one preferred aspect of the inventive subject matter, namely when a telephone data modem communication device is in use, since the telephone line can also be used for personal communications, the irrigation controller initiated calls will not interrupt a voice call that is in progress. Additionally, the irrigation controller (100) will drop its call-in-progress as soon as the user (home owner, business owner, etc.) picks up the phone to start dialing out. It is contemplated that if the call from the irrigation controller (100) to the data server (200) is interrupted, then the irrigation controller will initiate the call at a later time. Alternatively, the irrigation controller (100) can be assigned alternative calling times, if for any reason the communication between the irrigation controller (100) and data server (200) was not completed during the first assigned calling time.

Thus, specific embodiments and applications of irrigation controller communication systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specifications and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An irrigation controller programmed to automatically initiate communication with a data server to perform at least one of the following functions: (a) exchange irrigation data; (b) receive control data; and (c) receive synchronization data.

2. The irrigation controller of claim 1, wherein the irrigation data is station runtime history.

3. The irrigation controller of claim 1, wherein the irrigation data is evapotranspiration (ETo) data.

4. The irrigation controller of claim 1, wherein the control data involves station runtime settings.

5. The irrigation controller of claim 1, wherein the control data involves cycle and soak settings.

6. The irrigation controller of claim 1, wherein the synchronization data includes a date and a time.

7. The irrigation controller of claim 6, further comprising a microprocessor that is programmed to use the date and time to schedule a future contact with the data server.

8. An irrigation system, comprising:
an irrigation controller;
a data server; and
a software program that programs the irrigation controller to automatically initiate a telephone call from the irrigation controller to the data server to perform at least one of the following functions: (a) exchange irrigation data; (b) receive control data; and (c) receive synchronization data.
